(19) United States
(12) Patent Application Publication
(10) Pub. No.: US 2013/0215527 A1
(43) Pub. Date: Aug. 22, 2013

(54) OPTICALLY UN-OBSCURED CONTROLLABLE MIRROR FOR HIGH-SPEED BEAM STEERING AND PHASE ABERRATION COMPENSATION

(71) Applicants: Leonid A. Beresnev, Columbia, MD (US); Mikhail A. Vorontsov, Laurel, MD (US)

(72) Inventors: Leonid A. Beresnev, Columbia, MD (US); Mikhail A. Vorontsov, Laurel, MD (US)

(21) Appl. No.: 13/398,870

(22) Filed: Feb. 17, 2012

(51) Int. Cl. G02B 7/185

(52) U.S. Cl. 359/849

(57) ABSTRACT

Apparatus for correcting a distorted incident wavefront are disclosed herein. In some embodiments, an apparatus may include a deformable mirror haying a first surface; a plurality of bimorph actuators coupled to an opposing second surface of the deformable mirror to tilt the deformable mirror with respect to a first plane; at least one mount to convert first motions of the plurality of bimorph actuators to tilt the deformable mirror with respect to the first plane; and an assembly disposed between the at least one mount and the second surface of the deformable mirror to decouple the first motions of the plurality of bimorph actuators from second motions in the deformable mirror that deform the first surface, wherein the plurality of bimorph actuators, the at least one mount, and the assembly have a combined footprint that is smaller than a surface area of the first surface of the deformable mirror.

### GOVERNMENT INTEREST

Governmental Interest—The invention described herein may be manufactured, used, and licensed by or for the U.S. Government.

### FIELD OF INVENTION

Embodiments of the present invention generally relate to optical apparatus and, more particularly, to apparatus for correcting a distorted incident wavefront.

### BACKGROUND OF THE INVENTION

Wavefront correctors, for example, including deformable mirrors, liquid crystal phase modulators, or the like may be used in optical systems to control wavefront phase shape and optical wave propagation direction. For example, wavefront correctors may be utilized to correct atmospheric turbulences induced wavefront aberrations among other applications. Typical aberrations may include both high order and lower order aberrations. For example, low order aberrations may include tip/tilt, defocus, astigmatisms, comas, and the like. Low order aberrations may result in optical system degradation and thus require appropriate correction. For example, correction bandwidth may range from a few kilohertz (kHz) or higher. Existing wavefront correctors which may use a combination of piezoelectric stacks to control deformation of a deformable mirror and voice coil actuators to control tip/tilt of the deformable mirror have limitations, such as size, response time, and the like which cannot be scaled to include a large number of low order aberration corrections.

Therefore, the inventor has provided an improved apparatus for correcting a distorted incident wavefront.

### BRIEF SUMMARY OF THE INVENTION

Embodiments of the present invention include apparatus for correcting a distorted incident wavefront. In some embodiments, an apparatus for correcting a distorted incident wavefront may include a deformable mirror having a first surface to receive the distorted wavefront and to reflect a corrected wavefront; a plurality of bimorph actuators coupled to an opposing second surface of the deformable mirror to tilt the deformable mirror with respect to a first plane; at least one mount to convert first motions of the plurality of bimorph actuators to tilt the deformable mirror with respect to the first plane; and an assembly disposed between the at least one mount arid the second surface of the deformable mirror to decouple the first motions of the plurality of bimorph actuators from second motions in the deformable mirror that deform the first surface, wherein the plurality of bimorph actuators, the at least one mount, and the assembly have a combined footprint that is smaller than a surface area of the first surface of the deformable mirror.

In some embodiments, an apparatus for correcting a distorted incident wavefront may include a body having a first surface to receive the distorted wavefront and to reflect a corrected wavefront; an electro-active layer coupled to a second surface of the body opposite the first surface, wherein the electro-active layer is controllable to controllably deform the body; a plurality of electrodes coupled to the electro-active layer to provide a current to one of a plurality of regions of the electro-active layer to deform the region in a lateral direction; a ground electrode layer to return the current provided to the electro-active layer by the plurality of electrodes; a plurality of bimorph actuators facing the electro-active layer, wherein the plurality of bimorph actuators are configured to tilt the body with respect to a first plane, each bimorph actuator further includes a plurality of stacked layers include a first electro-active layer and a second electro-active layer, wherein the plurality of stacked layers have a first end coupled to a base and a second end opposing the first end; a first electrode disposed between the first and second electro-active layers to provide a current to deform the first and second electro-active layers to move the plurality of stacked layers in a first motion; and a plurality of grounding electrodes, each grounding electrode disposed on a surface of the first or second electro-active layer that is opposing a surface on which the first electrode is disposed; at least one mount to convert the first motion of each of the plurality of bimorph actuators to tilt the body with respect to the first plane; and an assembly disposed between the at least one mount and the second surface of the electro-active layer to decouple the first motions of each of the plurality of bimorph actuators from a second motion in the electro-active layer that deform the first surface, wherein the plurality of bimorph actuators, the at least one mount, and the assembly have a combined footprint that is smaller than a surface area of the first surface.

Other and further embodiments of the present invention are discussed below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIGS. 1A-C depict side schematic views of an apparatus for correcting a distorted incident wavefront in accordance with some embodiments of the present invention.

FIGS. 2A-E depict side schematic views of an apparatus for correcting a distorted incident wavefront in accordance with some embodiments of the present invention.

FIGS. 3A-D depict side schematic views of an apparatus for correcting a distorted incident wavefront in accordance with some embodiments of the present invention.

FIGS. 4A-B depict side schematic views of an apparatus for correcting a distorted incident wavefront in accordance with some embodiments of the present invention.

FIGS. 5A-B side schematic views of depict an apparatus for correcting a distorted incident wavefront in accordance with some embodiments of the present invention.

FIGS. 6A-B side schematic views of depict an apparatus for correcting a distorted incident wavefront in accordance with some embodiments of the present invention.

FIGS. 7A-B depict embodiments of components for an apparatus for correcting a distorted incident wavefront in accordance with some embodiments of the present invention.

FIG. 8 depicts exemplary apparatus including an apparatus for correcting a distorted incident wavefront in accordance with some embodiments of the present Invention.

FIG. 9 depicts an array of apparatus for correcting a distorted incident wavefront in accordance with some embodiments of the present invention.

### DETAILED DESCRIPTION OF THE INVENTION

Embodiments of the present invention comprise apparatus for correcting a distorted incident wavefront. Embodiments of the inventive apparatus advantageously permit for a broader range of low order aberration corrections and faster response times. Embodiments of the present invention may advantageously have a small footprint such that the elements used to tip/tilt and deform the mirror do not extend beyond the peripheral edges of the mirrored surface.

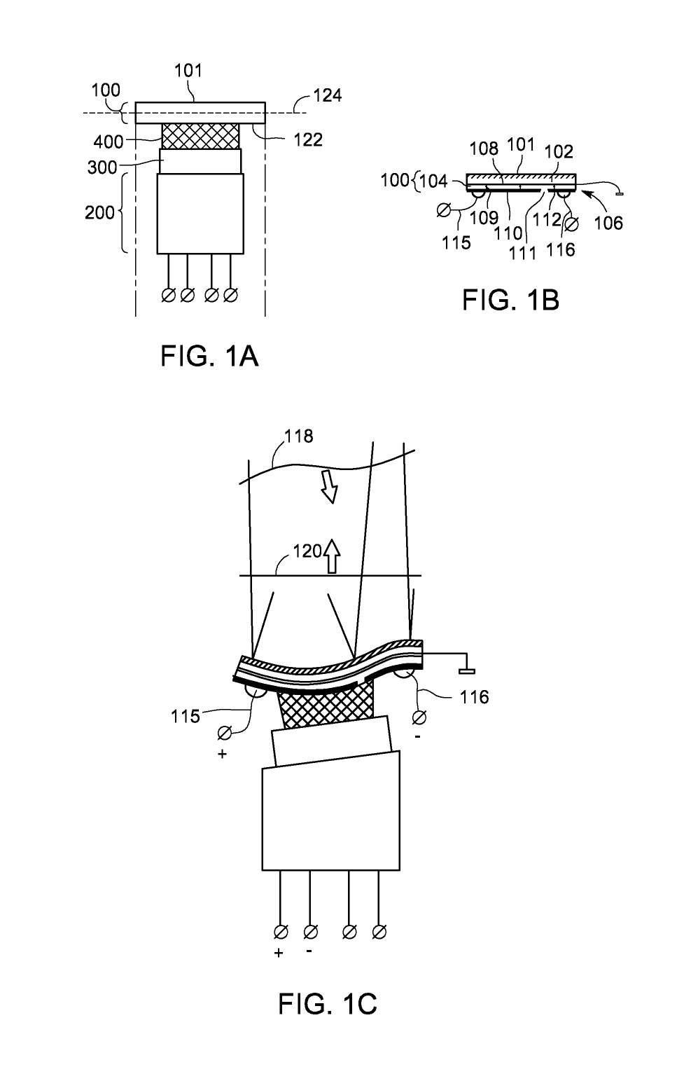

FIGS. 1A-C depict schematic side views of an apparatus for correcting a distorted incident wavefront in accordance with some embodiments of the present invention. For example, illustrated generally in FIG. 1A, the apparatus may include a deformable mirror 100 having a first surface 101 to receive the distorted wavefront (e.g., a distorted wavefront 118 as illustrated in FIG. 1C) and to reflect the corrected wavefront (e.g., a corrected wavefront 120 as illustrated in FIG. 1C). A plurality of bimorph actuators 200 may be coupled to an opposing second surface 122 of the deformable mirror 100 to tilt the deformable mirror with respect to a first plane 124. For example, as discussed herein, the bimorph actuators 200 may tilt the deformable mirror 100 in any direction with respect to the first plane 124. For example, tilt directions that are in the plane of the drawings disclosed herein are typically shown; however other tilt directions such as perpendicular to the plane of the drawings or any suitable directions are possible.

The apparatus includes at least one mount 300 as illustrated in FIG. 1A, where the at least one mount may convert first motions of the plurality of bimorph actuators to tilt the deformable mirror 100 with respect to the first plane 124. As illustrated in FIG. 1A, an assembly 400 may be disposed between the at least one mount 300 and the second surface 122 of the deformable mirror 100 to decouple the first motions of the plurality of bimorph actuators 200 from second motions in the deformable mirror 100 that deform the first surface 101, for example, as illustrated in FIG. 1C. As illustrated in FIG. 1A, the plurality of bimorph actuators 200, the at least one mount 300, and the assembly 400 have a combined footprint that is smaller than a surface area of the first surface 101 of the deformable mirror 100. The deformable mirror 100 may be deformed and tilted as illustrated in FIG. 1C to receive the distorted wavefront 118 and to reflect the corrected wavefront 120.

As illustrated in FIG. 1B, the deformable mirror 100 may include a body 102 having a first side that includes the first surface 101 of the deformable mirror 100. The body 102 may comprise any suitable material such as one or more of a glass, metal, a composite, such as polymer composite, metal composite, glass composite, or the like. An electro-active layer 104 may be coupled to a second side of the body 102 opposite the first side, where the electro-active layer 104 may be controllable to controllably deform the body 102 as illustrated in FIG. 1C. The electro-active layer 104 may include a piezoelectric plate, a ceramic, a crystal or any suitable materials capable of shrinking or expanding under applied electric voltage, for example, such as a piezoelectric ceramic in a d31 mode. As shown in FIG. 1B, the deformable mirror 100 may include a plurality of electrodes 106 coupled to the electro-active layer 104 to provide a current to a plurality of regions of the electro-active layer 104 to deform the plurality of regions. Exemplary electrodes 106, such as electrodes 110, 112 separated by an electrical gap 111 are illustrated in FIG. 1B. For example, the electrodes 110, 112 may receive current from wires 115, 116 respectively to provide to regions of the electro-active layer 104 disposed above the electrodes 110, 112. Electrodes 110, 112 are merely exemplary and any suitable number and/or pattern of the plurality of electrodes 106 may be utilized to achieve the desired amount of deformation in the body 102 of the deformable mirror 100. A ground electrode layer 108 may be used to return the current provided to the electro-active layer 104 by the plurality of electrodes 106. For example, as illustrated in FIG. 1B, the ground electrode 108 may be disposed between the body 102 and the electroactive layer 104. A direction 109 of electrical polarization is illustrated in FIG. 1B. For example, the direction 109 may be indicative of using a piezoelectric plate operating in a d31 mode as an electro-active layer 104. Other embodiments of the mirror 100 are possible, for example, the body 102 (which may be passive as described above, e.g., deformed by the electro-active layer 104) may be an active layer, e.g., capable of deformation under applied electrical voltage, in addition to electro-active layer 104.

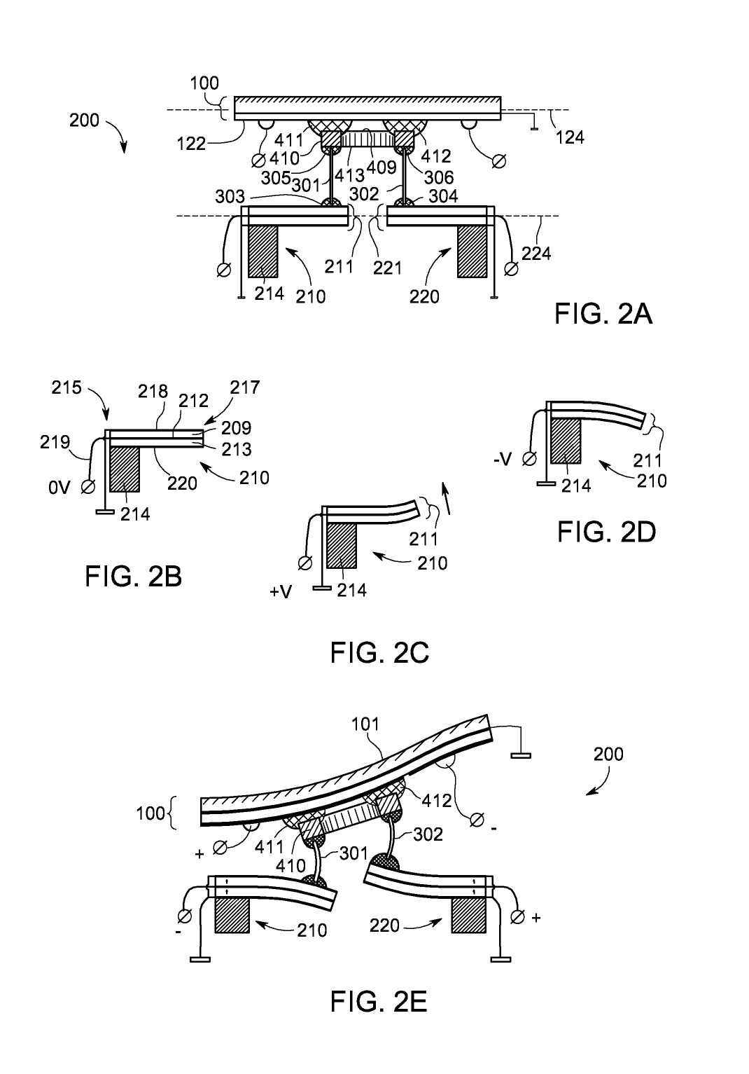

FIGS. 2A-E depict side schematic views of an apparatus for correcting a distorted incident wavefront in accordance with some embodiments of the present invention. For example, as illustrated in FIG. 2A, the apparatus includes the deformable mirror 100, and embodiments of the assembly 400, the at least one mount 300, and the plurality of bimorph actuators 200. As illustrated in FIG. 2A, the assembly 400 may include a ring 410 having a first side 409 and a second side 413. A plurality of elastic adhesive elements may couple the first side 409 of the ring 410 to the second surface 122 of the deformable mirror 100. Exemplary elastic adhesives elements may include elements 411, 412, which may be disposed about the first side 409 of the ring 410. For example, the elastic adhesive elements may include one or more of a soft adhesive, a flexible adhesive, silicone, rubber, or other suitable materials. The elastic adhesive elements may allow for the decoupling of the first motions of the plurality of bimorph actuators 200 from the second motions of the deformable mirror 100 as discussed above.

As illustrated in FIG. 2A, the at least one mount 300 may include a plurality of flexible rods, for example, including flexible rods 301, 302 as shown. Each rod 301, 302 may have a first end 303, 304 coupled to the plurality of bimorph actuators 200 and a second end 305, 306 coupled to the second side 413 of the ring 410. Each flexible rod 301, 302 may include one or more of a metal, a plastic, a composite or other suitable materials capable of flexible bending.

As illustrated in FIG. 2A, the first ends 303, 304 of the flexible rods 301, 302 may be coupled to a plurality of stacked layers 211, 221 of corresponding bimorph actuators 210, 220. The flexible rods 301, 302 may be coupled at their respective ends using any suitable adhesive such as a hard adhesive or the like. FIG. 2A illustrates a schematic cross section view of the apparatus. As such, a second set of flexible rods and a second set of bimorph actuators may be disposed in a plane perpendicular to the page of FIG. 2A (not shown). The second sets of flexible rods and bimorph actuators may have the same configuration as illustrated in FIG. 2A.

The bimorph actuators 210, 220 include the plurality of stacked layers 211, 221 respectively. For example, as illustrated in FIGS. 2A-D for the bimorph actuator 210, the plurality of stacked layers 211 may include a first electro-active layer 209 and a second electro-active layer 213. For example, the first and second electro-active layers 209, 213 may be piezoelectric sheets or the like. A first end 215 of the plurality of stacked layers 211 may be coupled to a base 214 and a second end 217 opposing the first end 215 may be free to move as illustrated in FIGS. 2C-D when a voltage is applied to deform the first and second electro-active layers 209, 213. A first electrode 212 may be disposed between the first and second electro-active layers 209, 213 to provide a current to deform the first and second electro-active layers 209, 213. For example, the current may be provided by a wire 219 which may be coupled a power supply or the like. A plurality of grounding electrodes 218, 220 may be disposed on surfaces of each of the first and second electro-active layers 209, 213 that oppose the surfaces on which the first electrode 212 may be disposed. As illustrated in FIG. 2B, when no voltage is applied, the plurality of stacked layers 211 may be parallel to the first plane 124. When a positive or negative bias is applied as shown in FIGS. 2C-D, the plurality of stacked layers 211 may move in a direction having a predominantly perpendicular component with respect to the first plane 124 when the deformed.

FIG. 2E depicts a schematic view of the apparatus where the bimorph actuators 210, 220 may operate via the flexible rods 301, 302 to transfer the motion of the bimorph actuators 210, 220 to tilt the deformable mirror 100. Further, the elastic adhesive elements 411, 412 may be shown in FIG. 2E to decouple the motions of the bimorph actuators 210, 220 from the motions of the deformable mirror 100.

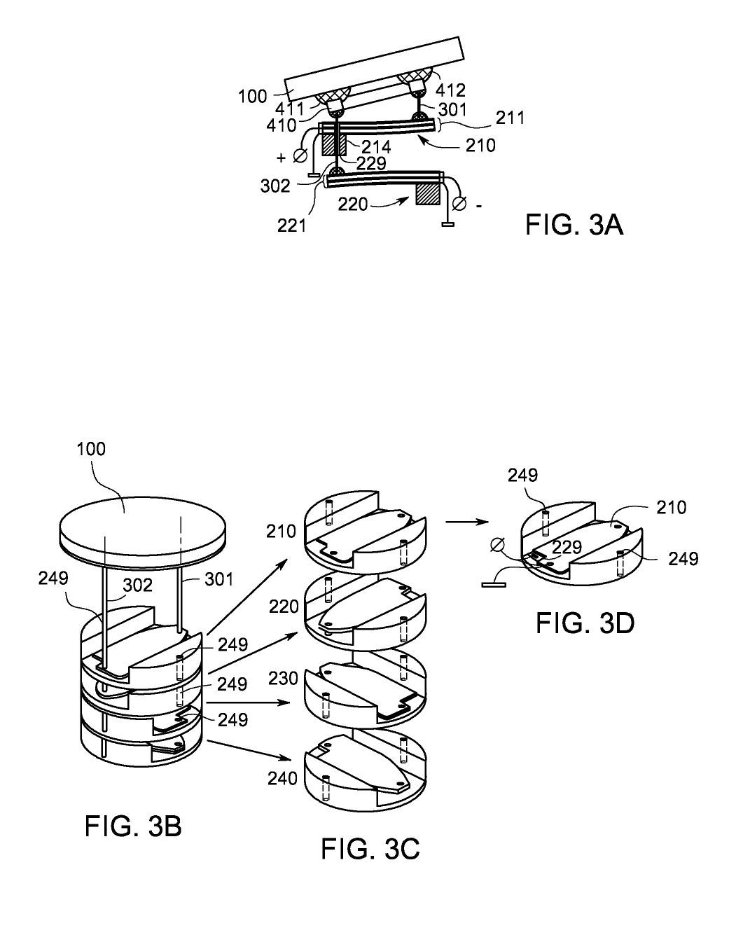

Embodiments of an apparatus as illustrated in FIGS. 2A-E depict an apparatus where the plurality of stacked layers of each bimorph actuator may be disposed in a second plane 224 parallel to the first plane 124. However, other embodiments of the apparatus are possible. For example, as illustrated in FIG. 3A-D, the plurality of bimorph actuators 210, 220 may be vertically stacked. As shown in FIG. 3A, the plurality of stacked layers 211 of the bimorph actuator 210 may include an opening 229 disposed therethrough such that the flexible rod 302 may pass through the opening 229 and contact the plurality of stacked layers 221 of the bimorph actuator 220 disposed below the bimorph actuator 210. As illustrated in FIG. 3A, the length of the flexible rod 302 may be greater than that of the flexible rod 301 for the embodiments shown in FIGS. 3A-D. Further, addition bimorph actuators 230, 240 are illustrated in FIGS. 3B-D. For example, the bimorph actuators 230, 240 may be stacked below the bimorph actuators 210, 220 and oriented in a plane perpendicular to that of the orientation of the bimorph actuators 210, 220. The bimorph actuators 210, 220, 230, 240 may have a modular design as illustrated in FIGS. 3B-D. Each module may include openings 249, for example, to allow flexible rods to pass through to a bimorph actuator disposed below. For example, as illustrated in FIG. 3A, the openings 249 in the modules of bimorph actuators 210, 220 allow a flexible rod (not shown) to pass through the modules of actuators 210, 220 to the bimorph actuator 230.

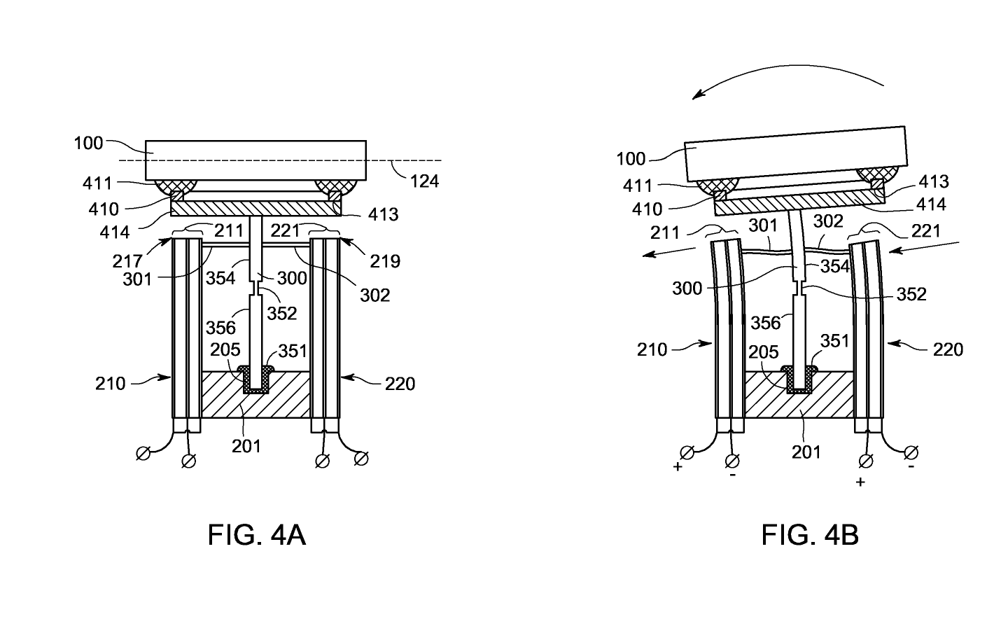

In some embodiments, such as illustrated in FIGS. 4A-B, the plurality of bimorph actuators may be oriented perpendicular to the first plane 124. For example, as shown in FIG. 4A-B, the plurality of stacked layers 211, 221 of the bimorph actuators 210, 220 may be perpendicular to the first plane 124 and may move in a direction having a predominantly parallel component with respect to the first plane 124 when deformed as illustrated in FIG. 4B. The bimorph actuators 210, 220 may share a common base 201 as shown. A bifurcated rod (e.g., mount 300) may be disposed in an opening 205 in the base 201 and secured in the opening 205 using a flexible adhesive 351 or the like. The bifurcated rod may extend from the base 201 to a plate 414 coupled to the second side 413 of the ring 410. The bifurcated rod may be coupled to the plate 414 by gluing, soldering, welding or the like. The ring 410, the plate 414, and the rod may be fabricated also from a singular piece of material such as metal, plastic or composite.

The bifurcated rod may include a notched section 352 for flexibility between a first section 354 and a second section 356 of the rod. As shown, the first section 354 may be disposed between the notched section 352 and the plate 414 and the second section 356 may be disposed between the notched section 352 and the base 201. The plurality of flexible rods, including the flexible rods 301, 302, may each coupled the first section 354 of the bifurcated rod to bifurcated rod facing surfaces of the plurality of bimorph actuators, such as including the second ends 217, 219 of the plurality of stacked layers 211, 221 of the bimorph actuators 210, 220 as illustrated in FIGS. 4A-B.

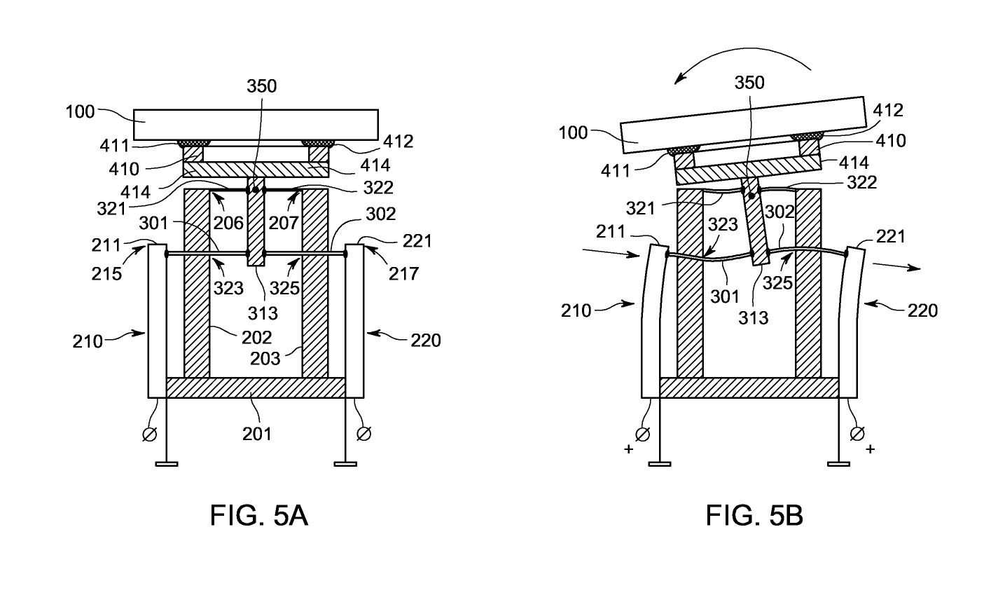

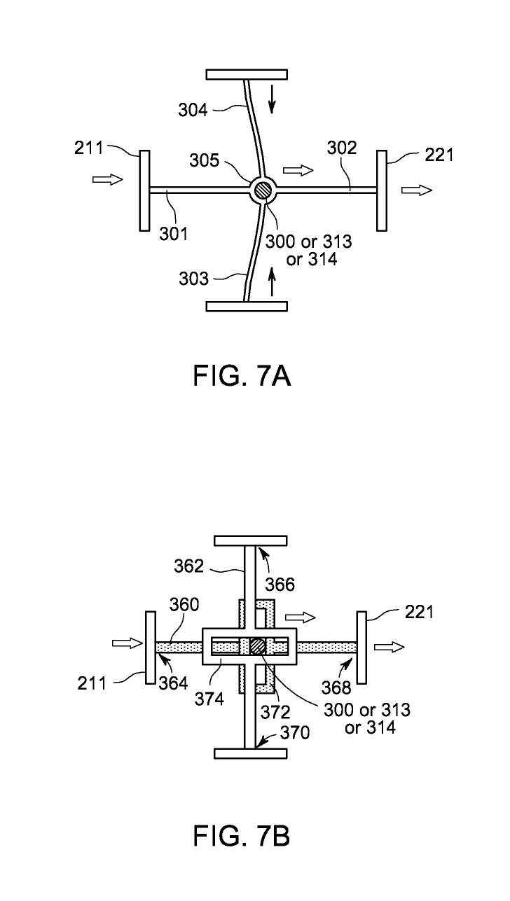

Other embodiments of the flexible rods 301, 302 are possible for the embodiments of the apparatus as illustrated in FIGS. 4A-4B. For example, as shown in FIG. 7A in a top down schematic view, a coupling element 305 may be disposed about the first section 354 of the rod 300 (or a rod 313 or a stem 314 as discussed below and illustrated in FIGS. 5A-B and 6A-B respectively) and coupling each of the flexible rods 301, 302, 303, 304 to the first section 354 of the mount 300. As shown, the coupling element 305 may be integrated with each of the plurality of flexible rods 301, 302, 303, 304. Alternatively, as shown in FIG. 7B, the plurality of flexible rods 301, 302, 303, 304 may be replaced with a plurality of rigid members 360, 362, wherein each rigid member 360, 362 has first ends 364, 366 and second ends 368, 370 coupled to opposing bifurcated rod facing surfaces of opposing bimorph actuators. Each rigid member 360, 362 includes a rectangular frame with an opening 372, 374 dispose therein, where the bifurcated rod 300 may be disposed through the openings in frames 372, 374.

FIGS. 5A-B depict alternative embodiments to at least some aspects of the apparatus as illustrated in FIGS. 4A-B. For example, as shown in FIG. 5A, a rod 313 may be coupled to the plate 414 and extending towards the base 201. As shown, the rod 313 does riot contact the base 201. A plurality of struts, including struts 202, 203 extend towards the deformable mirror 100 from the base 201 and may be disposed about the rod 313. Each strut 202, 203 may include a first end 206, 207 opposite the base 201. A plurality of first flexible rods, including flexible rods 321, 322 couple the rod 313 to corresponding first ends 206, 207 of struts 202, 203. Similar to embodiments of the apparatus as illustrated in FIG. 4A-B, and as shown in FIGS. 5A-B, a plurality of second flexible rods, including flexible rods 301, 302, couples the rod 313 to the plurality of bimorph actuators, for example, such as to corresponding second ends 215, 217 of the plurality of stacked layers 211, 221 of the bimorph actuators 210, 220 via corresponding openings 323, 325 dispose through struts 202, 203 between the bimorph actuators 210, 220 and the rod 313 as illustrated in FIGS. 5A-B. As discussed above, embodiments of the plurality of flexible rods, such as those illustrated in FIG. 7A-B may be utilized with embodiments of the apparatus illustrated in FIGS. 5A-B.

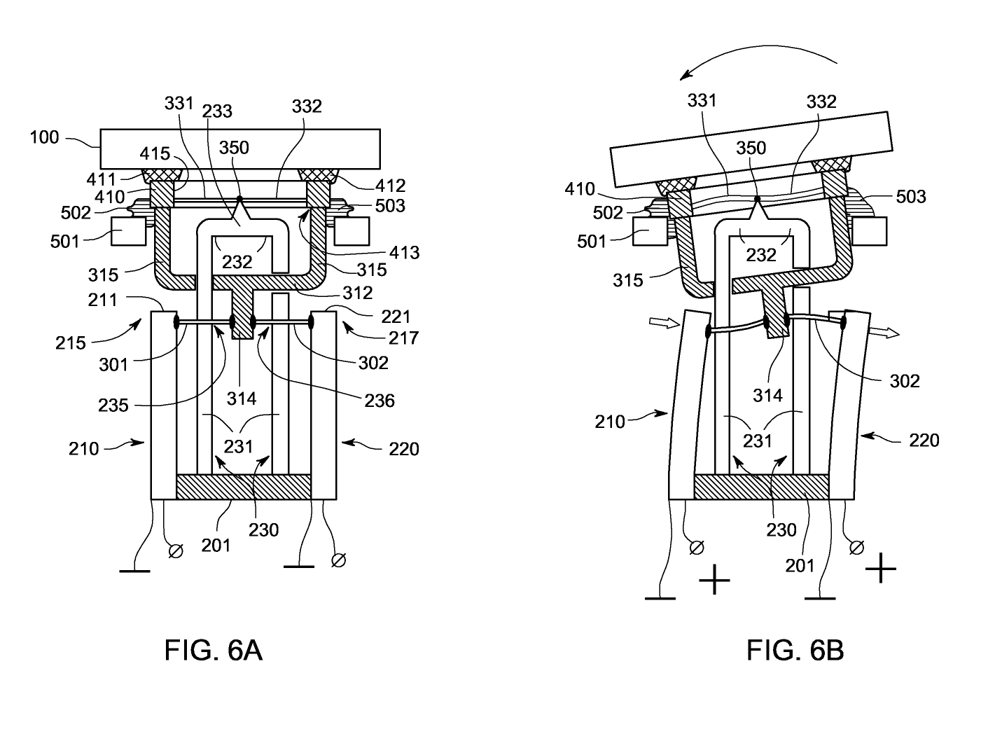

FIGS. 6A-B depict alternative embodiments to at least some aspects of the apparatus as illustrated in FIGS. 4A-B, 5A-B. For example, as shown in FIG. 6A, a fork shaped member 312 having a stem 314 and a plurality of arms 315 extending from the stem 314 towards the deformable mirror 100 may be coupled to the second side 413 of the ring 410. A plurality of struts 230 may extend towards the deformable mirror 100 from the base 201 and may be disposed about the stem 314 of the fork shaped member 312. Each strut 230 may include a vertical section 231 extending towards the deformable mirror 100 above the stem and a horizontal section 232, where each horizontal section couples together at a central point 233. A pivot 350 may extend from the central point 233 towards the deformable mirror 100. A plurality of first flexible rods, including flexible rods 331, 332 may couple the pivot 350 to a pivot facing surface 415 of the ring 410. Each of a plurality of second flexible rods, including the flexible rods 301, 302 may coupled the stem 314 to the plurality of bimorph actuators, such as to corresponding stem facing surfaces of second ends 215, 217 of the plurality of stacked layers 211, 221 of the bimorph actuators 210, 220 via corresponding openings 235, 236 disposed through each strut 230 between the bimorph actuator 210, 220 and the stem 314.

Further, although illustrated as passing through vertical sections 231 of the struts 230, the fork shaped member 312 may be staged between adjacent struts 230 such that the fork shaped member 312 does not contact the struts 230 directly when the bimorph actuators are deformed to tilt the deformable mirror 100 as illustrated in FIG. 6A.

Optionally, the apparatus as illustrated in FIGS. 6A-B may include a collar ring 501 disposed about the plurality of arms 315 of the forked shaped member 312. One or more elastic elements 502, 503 may be disposed between the collar ring 501 and the ring 410 to provide damping when the plurality of bimorph actuators, including actuators 210, 220 tilts the deformable mirror 100 with respect to the first plane 124. Further, and optionally, the collar ring 501 and elastic elements 502, 503 may be used with any of the embodiments of the apparatus disclosed herein, such as the embodiments illustrated in FIGS. 5A-B or other embodiments.

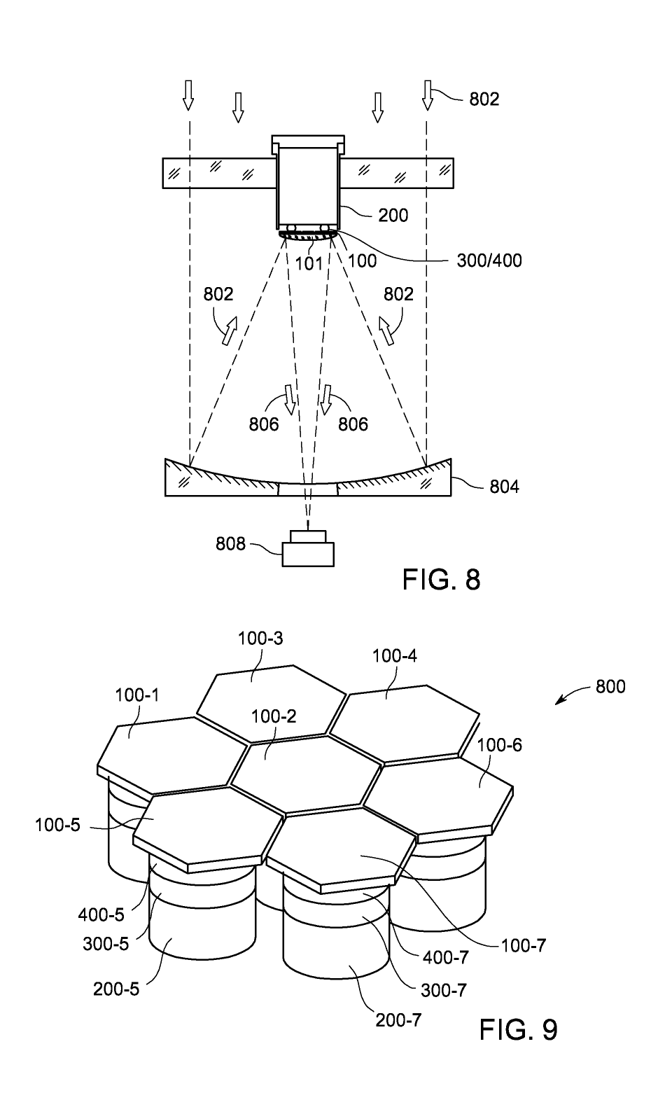

Embodiments of the apparatus discussed above may be implemented in various optical systems. For example, FIG. 8 depicts an optical system 800 having the apparatus disposed therein. For example, the optical system 800 may be a Cassegrain telescope or any suitable optical system which may require correction of an incident wavefront. For example, in operation a wavefront 802 may enter the system 800 and reflect off a primary mirror 804 towards the first surface 101 of the deformable mirror 100 as illustrated in FIG. 8. The wavefront 802 may be corrected and a corrected wavefront 806 may be reflected from the first surface 101 towards an imaging camera 808.

FIG. 9 depicts a plurality of apparatus disposed in an array, wherein the first surfaces 101 of adjacent apparatus may form a continuous first surface. For example, such an array may be made as a result of embodiments disclosed herein, wherein the reduced footprint of the plurality of bimorph actuators 200, the at least one mount 300 and the assembly 400 permit the first surfaces 101 of adjacent apparatus to form a continuous first surface, as illustrated in FIG. 9.

Various elements, devices, modules and circuits are described above in associated with their respective functions. These elements, devices, modules and circuits are considered means for performing their respective functions as described herein.

While the foregoing is directed to embodiments of the present invention, other and further embodiments of the invention may be devised without departing from the basic scope thereof, and the scope thereof is determined by the claims that follow.

1. A apparatus for correcting a distorted incident wavefront, comprising:
a deformable mirror having a first surface to receive the distorted wavefront and to reflect a corrected wavefront;
a plurality of bimorph actuators coupled to an opposing second surface of the deformable mirror to tilt the deformable mirror with respect to a first plane;
at least one mount to convert first motions of the plurality of bimorph actuators to tilt the deformable mirror with respect to the first plane; and
an assembly disposed between the at least one mount and the second surface of the deformable mirror to decouple the first motions of the plurality of bimorph actuators from second motions in the deformable mirror that deform the first surface, wherein the plurality of bimorph actuators, the at least one mount, and the assembly have a combined footprint that is smaller than a surface area of the first surface of the deformable mirror.

2. The apparatus of claim 1, wherein the deformable mirror further comprises:
a body having a first side including the first surface of the deformable mirror;
an electro-active layer coupled to a second side the body opposite the first side, wherein the electro-active layer is controllable to controllably deform the body;
a plurality of electrodes coupled to the electro-active layer to provide a current to a plurality of regions of the electro-active layer to deform the plurality of regions; and
a ground electrode layer to return the current provided to the electromotive layer by the plurality of electrodes.

3. The apparatus of claim 1, wherein each bimorph actuator further comprises:
a plurality of stacked layers including a first electro-active layer and a second electro-active layer, wherein the plurality of stacked layers have a first end coupled to a base and a second end opposing the first end;
a first electrode disposed between the first and second electro-active layers to provide a current to deform the first and second electro-active layers; and
a plurality of grounding electrodes, each grounding electrode disposed on a surface of the first or second electro-active layer that is opposing a surface on which the first electrode is disposed.

4. The apparatus of claim 3, wherein the plurality of stacked layers of each bimorph actuator are parallel to the first plane and wherein the plurality of stacked layers of each bimorph actuator moves in a direction having a predominantly perpendicular component with respect to the first plane when deformed.

5. The apparatus of claim 4, wherein the plurality of stacked layers of each bimorph actuator are disposed in a second plane parallel to the first plane.

6. The apparatus of claim 4, wherein the plurality of bimorph actuators are vertically stacked and wherein at least a first one of the plurality of stacked layers of a first one of the plurality of bimorph actuators includes an opening disposed through the first one of the plurality of stacked layers such that the at least one mount may pass through the opening and contact a second one of the plurality of stacked layers of a second one of the plurality of bimorph actuators disposed below the first one of the plurality of bimorph actuators.

7. The apparatus of claim 4, wherein the at least one mount further comprises:
a plurality of flexible rods, each flexible rod having a first end coupled to one of the plurality of stacked layers of one of the plurality of bimorph actuators and having a second end coupled to the assembly.

8. The apparatus of claim 7, wherein the assembly further comprises:
a ring haying a first side and a second side, wherein each second end of each of the plurality of flexible rods is coupled to the second side of the ring; and
a plurality of elastic adhesive elements coupling the first side of the ring to the second surface of the deformable mirror.

9. The apparatus of claim 3, wherein the plurality of stacked layers of each bimorph actuator is perpendicular to a first plane and wherein the plurality of stacked layers of each bimorph actuator moves in a direction having predominantly parallel component with respect to the first plane when deformed.

10. The apparatus of claim 9, wherein the assembly further comprises:
a ring having a first side and a second side; and
a plurality of elastic adhesive elements coupling the first side of the ring to the second surface of the deformable mirror.

11. The apparatus of claim 9, wherein the plurality of bimorph actuators share the base and wherein the assembly further comprises a plate coupled to the second side of the ring.

12. The apparatus of claim 11, wherein the at least one mount further comprises:
a bifurcated rod include a notched section for flexibility between a first section and a second section of the rod, wherein the first section is disposed between the notched section and the plate of the assembly and wherein the second section is disposed between the notched section and the base of the plurality of bimorph actuators;

13. The apparatus of claim 12, wherein the at least one mount further comprises:
a plurality of flexible rods, each flexible rod coupled the first section of the bifurcated rod to a bifurcated rod facing surface of a second end of a plurality of stacked layers of a bimorph actuator.

14. The apparatus of claim 13, wherein the plurality of flexible rods further comprise:
a coupling element disposed about the first section and coupling each of the flexible rods to the first section, wherein the coupling element is integrated with each of the plurality of flexible rods.

15. The apparatus of claim 12, wherein the at least one mount further comprises:
a plurality rigid members, each rigid member having first and second ends respectively coupled to opposing bifurcated rod facing surfaces of opposing bimorph actuators and having an opening disposed therein and having the bifurcated rod disposed through the opening.

16. The apparatus of claim 11, wherein the at least one mount further comprises:
a rod coupled to the plate of the assembly and extending towards the base of the plurality of bimorph actuators;
a plurality of struts extend towards the deformable mirror from the base and disposed about the rod, wherein each strut has a first end opposite the base;
a plurality of first flexible rods, wherein each first flexible rod couples the rod to a first end of one of the plurality of struts; and
a plurality of second flexible rods, wherein each second flexible rod couples the rod to a rod facing surface of a second end of a plurality of stacked layers of a bimorph actuator via an opening disposed through a strut between the bimorph actuator arid the rod,

17. The apparatus of claim 9, wherein the plurality of bimorph actuators share the base and wherein the at least one mount further comprises:
a fork-shaped member having a stem and a plurality of arms extending from the stem towards the deformable mirror arid coupled to second side of the ring of the assembly;
a plurality of struts extend towards the deformable mirror from the base and disposed about the stem, wherein each strut has a vertical section extending towards the deformable mirror above the stem and a horizontal section and wherein the horizontal sections of the plurality of struts are couple together at a central point;
a pivot extending from the central point of the plurality of struts towards the deformable mirror;
a plurality of first flexible rods, wherein each flexible rod couples the pivot to a pivot facing surface of the ring of the assembly; and
a plurality of second flexible rods, wherein each second flexible rod couples the stem to a stem facing surface of a second end of a plurality of stacked layers of a bimorph actuator via an opening disposed through a strut between the bimorph actuator and the stem.

18. The apparatus of claim 17, further comprising:
a collar ring disposed about the plurality of arms of the fork shaped member; and
one or more elastic elements disposed between the collar ring and the ring of the assembly to provide damping when the plurality of bimorph actuators tilt the deformable mirror with respect to the first plane.

19. A apparatus for correcting a distorted incident wavefront, comprising:
a body having a first surface to receive the distorted wavefront and to reflect a corrected wavefront;
an electro-active layer coupled to a second surface of the body opposite the first surface, wherein the electro-active layer is controllable to controllably deform the body;
a plurality of electrodes coupled to the electro-active layer to provide a current to one of a plurality of regions of the electro-active layer to deform the region in a lateral direction; and
a ground electrode layer to return the current provided to the electro-active layer by the plurality of electrodes;
a plurality of bimorph actuators facing the electro-active layer, wherein the plurality of bimorph actuators are configured to tilt the body with respect to a first plane, each bimorph actuator further comprising:
a plurality of stacked layers include a first electro-active layer and a second electro-active layer, wherein the plurality of stacked layers have a first end coupled to a base and a second end opposing the first end;
a first electrode disposed between the first and second electro-active layers to provide a current to deform the first and second electro-active layers to move the plurality of stacked layers in a first motion; and
a plurality of grounding electrodes, each grounding electrode disposed oh a surface of the first or second electro-active layer that is opposing a surface on which the first electrode is disposed;
at least one mount to convert the first motion of each of the plurality of bimorph actuators to tilt the body with respect to the horizontal plane; and
an assembly disposed between the at least one mount and the second surface of the electro-active layer to decouple the first motions of each of the plurality of bimorph actuators from a second motion in the electro-active layer that deform the first surface, wherein the plurality of bimorph actuators, the at least one mount, and the assembly have a combined footprint that is smaller than a surface area of the first surface.

20. The apparatus of claim 19, wherein the plurality of stacked layers of each bimorph actuator is either perpendicular or parallel to the first plane and wherein the plurality of stacked layers of each bimorph actuator moves in either a first direction having predominantly parallel component or a second direction having a predominantly perpendicular component with respect to the first plane when deformed.
